(19) United States
(12) Patent Application Publication
(10) Pub. No.: US 2010/0213843 A1
(43) Pub. Date: Aug. 26, 2010

(54) HIGH-PRESSURE DISCHARGE LAMP HAVING AN IMPROVED IGNITION DEVICE, AND IGNITION DEVICE FOR A GAS DISCHARGE LAMP

(75) Inventor: Andreas Kloss, Neubiberg (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/663,004

(22) PCT Filed: May 29, 2008
(86) PCT No.: PCT/EP2008/056591

§ 371 Date: Dec. 4, 2009

(30) Foreign Application Priority Data
Jun. 6, 2007 (DE) 10 2007 026 317.3

(51) Int. Cl. H01J 7/44

(52) U.S. Cl. 315/51

(57) ABSTRACT

A high-pressure discharge lamp is provided. The high-pressure discharge lamp may include a discharge vessel; and an ignition device which comprises at least one spiral pulse generator that is configured to generate high-voltage pulses, the ignition device being integrated in the high-pressure discharge lamp; wherein the ignition device comprises a charging resistor which is formed entirely or partially by a PTC thermistor.

### TECHNICAL FIELD

The invention relates to a high-pressure discharge lamp according to the precharacterizing clause of claim 1. Such lamps are in particular high-pressure discharge lamps for general lighting or for photo-optical purposes. The invention furthermore relates to an ignition device with an improved operating process, which may be used in particular for such a lamp.

### PRIOR ART

The problem of igniting high-pressure discharge lamps is currently resolved by integrating the ignition apparatus into the ballast apparatus. A disadvantage of this is that the supply leads must be made high-voltage proof.

In the past, there have repeatedly been attempts to integrate the ignition unit into the lamp. Primarily, attempts have been made to integrate it into the cap. Particularly effective ignition, offering high pulses, is achieved by means of so-called spiral pulse generators such as are disclosed for example in U.S. Pat. No. 3,289,015. Some time ago, such apparatuses were proposed for various high-pressure discharge lamps such as metal halide lamps or high-pressure sodium lamps, see for example U.S. Pat. No. 4,325,004 and U.S. Pat. No. 4,353,012. They were not however widely successful, because on the one hand they are too expensive. On the other hand, the advantage of building them into the cap is not sufficient, since the problem of feeding the high voltage into the bulb remains. The likelihood of damage to the lamp, whether insulation problems or breakdown in the cap, therefore increases greatly. Previously, it has not generally been possible to heat conventional ignition apparatus to more than 100° C.-150° C. The voltage generated then had to be fed to the lamp, which requires supply leads and lamp fixtures with corresponding high-voltage strength, typically about 5 kV or more.

The functionality of a spiral pulse generator will be explained briefly below with the aid of FIGS. 1 and 2a and 2b. A spiral pulse generator 1 consists of a winding of two conductive layers, between which an insulation material is placed. The material of the insulation material may be a material with a high dielectric constant or a material with a high permeability, or a mixture of the two materials. FIG. 2a shows the representation of a schematic structure of a spiral pulse generator 1. The conductive layer A is contacted at the end points A1 and A2. The layer B extending parallel is contacted only at one end point B1. The terminal A1 is at the voltage U₀, as provided by the electronic operating apparatus. The terminal A2 is the output, and is connected to the gas discharge lamp. The terminal B1 of the conductive layer B is connected via a charging resistor 7 to the ground terminal. The two conductive layers, with the dielectric lying between them, form a capacitor which is charged to the open-circuit voltage U₀ via the terminals A1 and B1. The terminals A1 and B1 are connected to a high-speed switch 3, for example a spark gap. The switch switches at a particular threshold voltage, which is somewhat lower than U₀. After the switch is closed, a voltage pulse is formed at the spiral pulse generator and propagates like a wave from the point of the switch along the spiral pulse generator to the point A2, where it is reflected and propagates back again. A voltage UA, which can be expressed as UA=2×n×U₀×η, is then built up at the point A2. η is the efficiency of the spiral pulse generator. After ignition of the lamp, the lamp current is fed through the conductive layer A in order to operate the lamp.

The spiral pulse generator now used is in particular a so-called LTCC component. This material is a special ceramic, which can be made thermally stable up to 500° C. or 600° C. LTCC has in fact already been used in connection with lamps, see U.S. 2003/0001519 and U.S. Pat. No. 6,853,151. Nevertheless, it was used for very different purposes in lamps which experience scarcely any thermal stress, with typical temperatures lower than 100° C. The particular benefit of the high thermal stability of LTCC in connection with the ignition of high-pressure discharge lamps, such as above all metal halide lamps with ignition problems, has not yet been recognized.

If the ignition device is now integrated into the outer bulb of the high-pressure discharge lamp, then the problem may arise that when the high-pressure discharge lamp is suddenly extinguished during operation and the ignition apparatus is not configured for hot reignition, the open-circuit voltage of the operating apparatus is still applied to the lamp and the integrated ignition apparatus attempts to ignite the lamp again. Since most high-pressure discharge lamps have a significantly increased ignition voltage when they are still hot, the ignition of an extinguished lamp does not take place for about 1-5 min after extinguishing. During this time the discharge vessel in the lamp cools, the pressure in it decreases and the ignition voltage therefore decreases again from >20 kV to the rated value of typically 3-5 kV. These attempts at ignition are not only unnecessary, but may also damage the discharge tube and the ignition apparatus.

### OBJECT

It is therefore an object of the present invention to provide a high-pressure discharge lamp having an integrated ignition apparatus, which prevents all attempts at ignition after sudden extinguishing of the lamp, for a period of time which is typically required for cooling the discharge tube.

This object is achieved by the characterizing features of claim 1.

Particularly advantageous configurations may be found in the dependent claims.

It is also an object of the present invention to provide an ignition device, which can be driven by a refined method and therefore prevent attempts at ignition after sudden extinguishing of the lamp for a certain time. This object is achieved by the characterizing features of claim 5.

### SUMMARY OF THE INVENTION

According to the invention the charging resistor 7, which is required for charging the integrated spiral pulse generator 1, is partly or entirely replaced by a PTC thermistor 73 which heats up together with the lamp 55 and, in the hot state, the resistance of the PTC thermistor 73 is dimensioned so that the threshold voltage of the threshold switch 3 is not reached. High-voltage pulses are therefore no longer generated, and attempts at igniting the lamp 55 when it is hot are reliably prevented.

### BRIEF DESCRIPTION OF THE DRAWING(S)

FIG. 1 Basic structure of a gas discharge lamp containing an ignition arrangement with a spiral pulse generator in the outer bulb according to the prior art.

FIG. 2a Basic structure of a spiral pulse generator.

FIG. 2b Simplified representation of a spiral pulse generator.

FIG. 3 Inventive structure of a gas discharge lamp containing an ignition arrangement with a spiral pulse generator in the outer bulb.

FIG. 4 Signal profiles of relevant voltages for a hot lamp and a cold lamp.

FIG. 5 Typical resistance behavior of a PTC thermistor as a function of temperature.

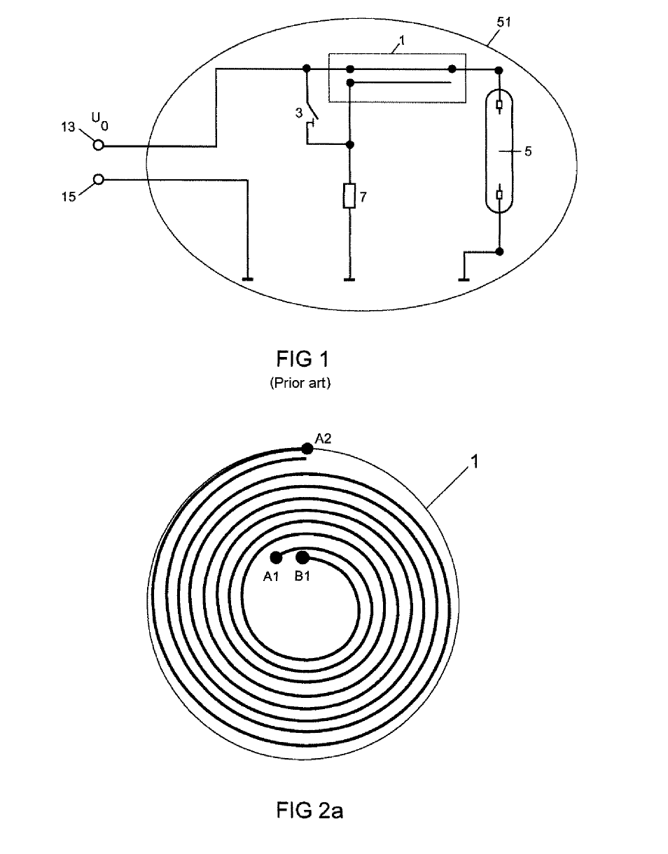

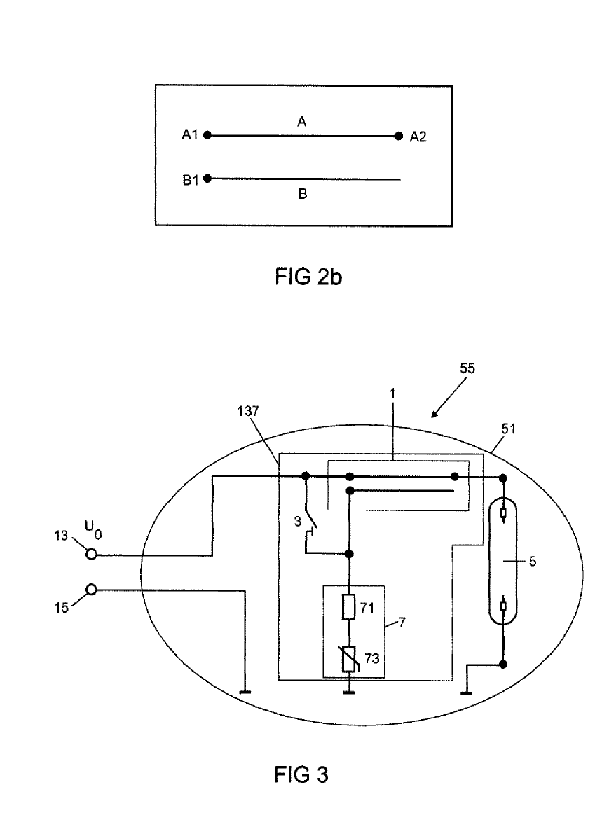

### PREFERRED EMBODIMENT OF THE INVENTION

FIG. 3 shows the basic structure of a high-pressure discharge lamp 55 according to the invention having an ignition apparatus 137, which is integrated in the outer bulb 51 and is composed of the spiral pulse generator 1, a threshold value switch 3 and a charging resistor 7. Here, the charging resistor 7 consists entirely or partly of a PTC thermistor 73, in series with which a resistor 71 is also connected depending on the layout. The PTC thermistor 71 is arranged in the lamp bulb so that it is heated via radiation exchange or convection by the discharge tube 5 of the high-pressure discharge lamp 55.

When the high-pressure discharge lamp is switched on, the lamp voltage U₀ is applied to the lamp contacts 13, 15. The spiral pulse generator is charged with this voltage via the charging resistor 7, until the voltage at the spiral pulse generator exceeds the threshold value voltage of the threshold value switch 3. Because the PTC thermistor is highly conductive, there is only a small voltage drop at the charging resistor and the spiral pulse generator is charged rapidly. The threshold value switch is preferably a spark gap. As soon as the spark gap breaks down, an ignition pulse is generated and the process begins again.

When a discharge takes place in the discharge tube 5 owing to the ignition pulse and the discharge tube begins to luminesce, it is heated to very high temperatures of more than 1000° C. within a short time. The PTC thermistor 75, which is placed in the vicinity of the discharge tube, is heated by the radiation of the discharge tube 5. In the case of a gas-filled outer bulb, the PTC thermistor 73 is additionally heated by convection effects. Since the lamp voltage of the high-pressure discharge lamp is generally much less than the open-circuit voltage, the breakdown voltage of the spark gap is no longer exceeded even when the PTC thermistor is still cold, so that no further ignition pulse generation takes place after lamp breakdown.

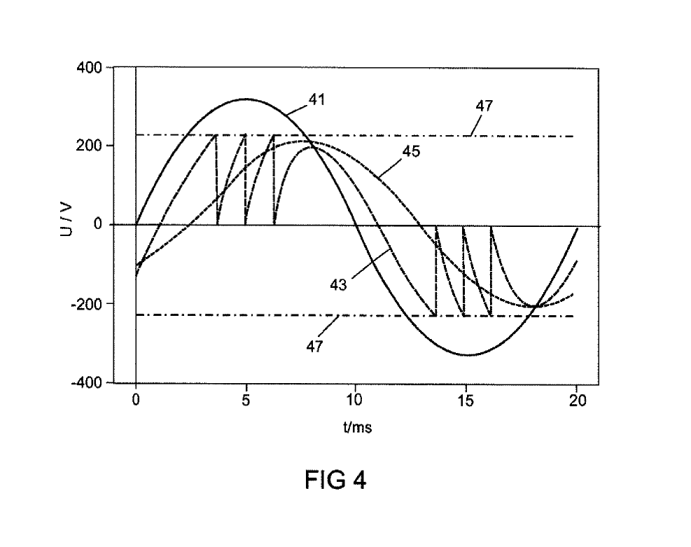

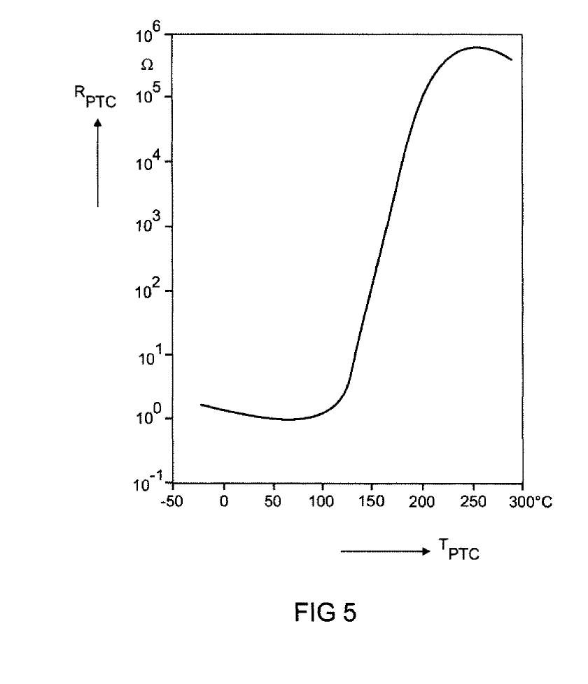

If the arc discharge in the discharge tube is extinguished owing to unpredicted effects, it can no longer be ignited for a certain time since the ignition voltage of a hot discharge tube is many times greater than the ignition voltage of a cold discharge tube. However, the voltage applied to the lamp immediately increases again to the open-circuit voltage after the arc discharge is extinguished. Nevertheless, the PTC thermistor has been heated so that its resistance, as may be seen in FIG. 5, is greatly increased. The voltage applied to the spiral pulse generator therefore decreases so that it lies below the breakdown value of the spark gap, and attempts at igniting a lamp when it is hot are reliably avoided (FIG. 4).

The resistance of the PTC thermistor 73 does not decrease to a value which again allows ignition until the lamp, and therefore the PTC thermistor 73, have correspondingly cooled. The spiral pulse generator 1 is thereupon slowly charged again to a voltage which lies above the breakdown voltage of the discharge gap 3, and ignition is again initiated.

Because the PTC thermistor 73 is in direct radiation exchange with the discharge tube 5 even after it has been extinguished, and with the surrounding outer bulb 51, it cools approximately with the same time constant as the outer bulb. Ignition is therefore effectively made possible again only when the lamp has cooled sufficiently.

Once the lamp, and therefore the PTC thermistor, have fully cooled to a temperature which gives the PTC thermistor a low resistance, then about 3-4 ignition pulses are generated per half-wave during the ignition process.

The signal profiles for a hot lamp and a cold lamp are represented in FIG. 4. Signal 41 shows the open-circuit voltage, as is applied to the lamp. Signal 43 is the voltage profile at the spiral pulse generator for a cold lamp. The voltage 43 increases to the breakdown voltage 47 of the spark gap, and then rapidly returns to zero owing to the short-circuit. This is repeated three times within one half-wave. Signal 45, on the other hand, represents the voltage at the spiral pulse generator when the spark gap is hot. The voltage increases much more slowly owing to the high resistance, and does not reach the breakdown voltage of the spark gap. No ignition is therefore initiated when the lamp is hot.

1. A high-pressure discharge lamp, comprising:
a discharge vessel; and
an ignition device which comprises at least one spiral pulse generator that is configured to generate high-voltage pulses, the ignition device being integrated in the high-pressure discharge lamp;
wherein the ignition device comprises a charging resistor which is formed entirely or partially by a PTC thermistor.

2. The high-pressure discharge lamp as claimed in claim 1, wherein the PTC thermistor is fitted in the high-pressure discharge lamp so that it is in direct radiation exchange with the discharge vessel.

3. The high-pressure discharge lamp as claimed in claim 1, wherein the PTC thermistor is entirely or partially provided with a radiation-absorbent coating.

4. The high-pressure discharge lamp as claimed in claim 1, wherein the outer bulb is not transparent for long-wavelength radiation.

5. An ignition device for a high-pressure discharge lamp, the ignition device comprising:
a spiral pulse generator;
a threshold value switch; and
a charging resistor;
wherein the ignition device comprises a charging resistor which is formed entirely or partially by a PTC thermistor.

6. The ignition device as claimed in claim 5, wherein the PTC thermistor is fitted in the lamp so that it is in direct radiation exchange with the discharge vessel.

7. The ignition device as claimed in claim 5, wherein the PTC thermistor is entirely or partially provided with a radiation-absorbent coating.

8. The ignition device as claimed in claim 5, wherein the threshold value switch is a spark gap.

9. The high-pressure discharge lamp as claimed in claim 1, further comprising:
an outer bulb;
wherein the discharge vessel is fitted in the outer bulb.
